(19) United States
(12) Patent Application Publication
(10) Pub. No.: US 2022/0415167 A1
(43) Pub. Date: Dec. 29, 2022

(54) Artificially Intelligent Traffic Management Sensor and Artificially Intelligent Traffic Management System Implemented in Part on A Distributed Ledger

(71) Applicant: Tradewinds Technology, LLC, Carlsbad, CA (US)

(72) Inventors: Peter David Whitmarsh, Carlsbad, CA (US); Shana Whitmarsh, Carlsbad, CA (US)

(21) Appl. No.: 17/848,254

(22) Filed: Jun. 23, 2022

Related U.S. Application Data
(60) Provisional application No. 63/214,233, filed on Jun. 23, 2021.

(51) Int. Cl. G08G 1/01

(52) U.S. Cl. CPC G08G 1/0133; G08G 1/0145; G08G 1/0141

(57) ABSTRACT

A method of controlling moving objects in and around a geographic location is provided. The method includes obtaining an artificially intelligent (“AI”) traffic management sensor in communication with an AI traffic management server; detecting one or more moving objects via the AI traffic management sensor; and relaying instruction information regarding a movement path in and/or through a geographic location from the AI traffic management sensor to the one or more moving objects.

### CROSS-REFERENCE TO RELATED APPLICATION

This application claims the benefit of U.S. Provisional Patent Application Ser. No. 63/214,233 which was filed on Jun. 23, 2021, the contents of which are incorporated herein by reference in their entirety.

### BACKGROUND

The subject technology relates generally to traffic management. More particularly, the subject technology relates to artificially intelligent (“AI”) traffic management sensors and AI traffic management systems and methods that manage, control mitigate, and direct traffic management through an area including air traffic, ground traffic, and sea traffic.

As nations become more carbon-neutral and start exploring and administrating a more carbon-free transportation solution with non-carbon vehicles, they will want quicker, more efficient, smarter, and carbon-free vehicles. New modes of transportation such as autonomous vehicles will be able to fly, drive, or sail within a given space, such as an airspace, ground, and sea in and surrounding a particular geographic location, such as a city.

It is anticipated that there will be a high demand for such autonomous vehicles, and that they will populate cities in large numbers. This can lead to increased congestion and a need to be able to manage a large number of autonomous vehicles and non-autonomous vehicles to ensure safety and efficiency of traffic through cities.

### SUMMARY

Accordingly, in one example of the present disclosure, a method of controlling moving objects in and around a geographic location is provided. The method can comprise obtaining an artificially intelligent (“AI”) traffic management sensor in communication with an AI traffic management server, detecting one or more moving objects via the AI traffic management sensor, and relaying instruction information regarding a movement path in and/or through a geographic location from the AI traffic management sensor to the one or more moving objects.

In some examples the one or more moving objects can be detected by receiving identification information from the one or more moving objects via an identification chip corresponding to each of the one or more moving objects. The identification information can comprise a private key to access a virtual wallet stored in the AI traffic management server. The virtual wallet can store authentication media for gaining access for travel within the geographic location. The authentication media can comprise at least one of stored payment method for gaining access for travel within the geographic location and authorization to travel in one or more portions of the geographic location.

In some examples, the method can also comprise authenticating the one or more moving objects based on the identification information received from the one or more moving objects. The instruction information regarding the movement path that is relayed to the moving objects can comprise solutions regarding the movement path based on machine learning performed on the AI traffic management server. The solutions can be in accordance with pretraining programmed into the AI traffic management server. The pretraining can account for at least one function of collision avoidance, energy efficiency, and time to arrive at a destination.

In some examples the detecting one or more moving objects can comprise sending a query from the AI traffic management sensor to the one or more moving objects for identification information. When no response to the query is received at the AI traffic management sensor, the method can further comprise sending a command to the one or more moving objects via the AI traffic management sensor to travel away from the geographic location or to land at a designated area. When the one or more moving objects fails to comply with the command sent from the AI traffic management sensor, the method can further comprise commandeering control of the one or more moving objects via the AI traffic management sensor to directly control the one or more moving vehicles. The commandeering step can comprise receiving solutions generated from the AI traffic management server at the AI traffic management sensor to hack into a control system of the one or more moving objects.

In another example, a system for controlling moving objects in and around a geographic location can be provided. The system can comprise one or more artificially intelligent (“AI”) sensors that can be operable to detect the moving objects and to transmit instruction information to the moving objects regarding a path through the environment, and one or more AI servers that can be communicatively coupled to the one or more AI sensors. The one or more AI servers can be operable to detect and predict traffic events of the moving objects.

In some examples, the system can further comprise one or more decentralized servers hosting a distributed ledger. The distributed ledger can comprise transaction information utilizing virtual wallets associated with each of the moving objects. The transaction information can correspond to a transaction of authentication media to allow the moving objects to travel within the geographic location. The virtual wallets can be accessed by the one or more decentralized servers by receiving identification information from the moving objects via an identification chip corresponding to each of the moving objects. The identification information can comprise a private key to access a virtual wallet stored in the AI traffic management server.

In another example, an artificially intelligent (“AI”) sensor can comprise an AI chip disposed within the AI sensor, one or more sensors configured to detect moving objects in and around a geographic location, and a transceiver configured to send and receive information to and from the moving objects in and around the geographic location. The transceiver can be operable to receive identification information from the moving object via an identification chip corresponding to each of the moving objects. The identification information can comprise a private key to access a virtual wallet stored in an AI traffic management server communicatively coupled to the AI. The virtual wallet can store authentication media for gaining access for travel within the geographic location, and the transceiver can be operable to relay instruction information regarding a movement path in and/or through a geographic location from the AI traffic management server to the one or more moving objects based on authenticating the moving objects via the authentication media.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a schematic view of an artificially intelligent traffic management system in accordance with one exemplary embodiment;

FIG. 2 is a schematic view of an artificially intelligent traffic management sensor; and

FIG. 3A and FIG. 3B show a method of traffic management according to one exemplary embodiment.

Reference will now be made to the exemplary embodiments illustrated, and specific language will be used herein to describe the same. It will nevertheless be understood that no limitation of the scope of the invention is thereby intended.

### DETAILED DESCRIPTION OF EMBODIMENTS

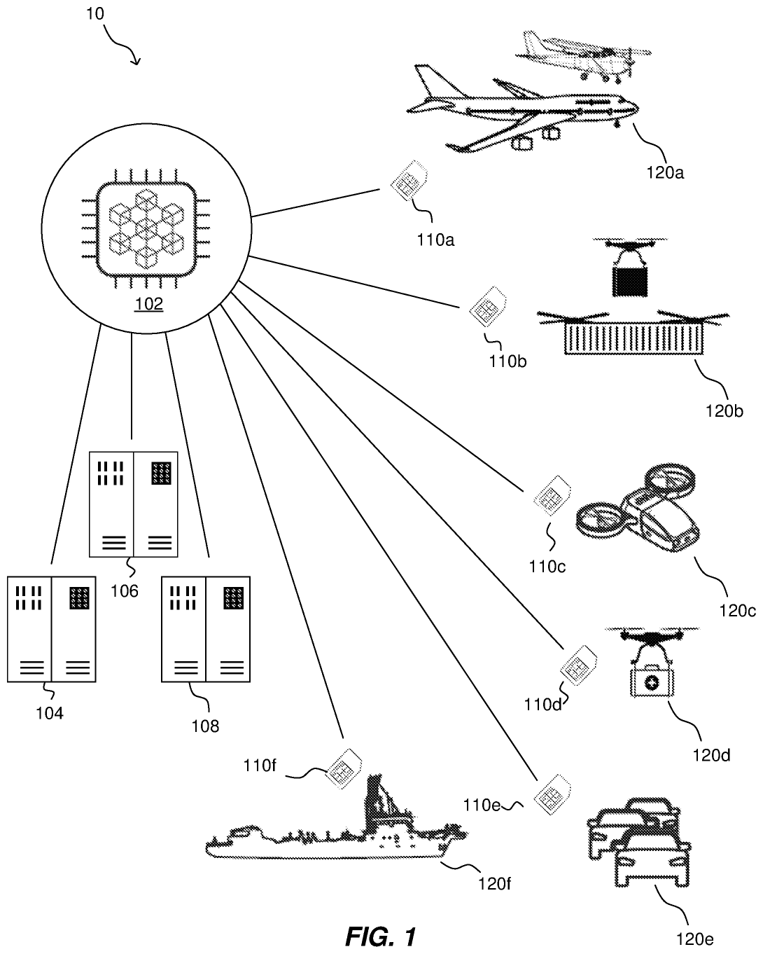

As illustrated in FIG. 1, an artificially intelligent (“AI”) traffic management system, indicated generally at 10, is provided. The AI traffic management system 10 is operable to manage, direct, and protect traffic within a particular geographic location. The traffic can include air traffic, ground traffic, or sea traffic. The geographic location can comprise a city, a county, or any other defined geographic location and can include an airspace, ground, and waterways in and surrounding the geographic location.

The system 10 can comprise an AI traffic management sensor 102. The AI traffic management sensor 102 can be operable to detect and communicate with a plurality of vehicles moving in and around the geographic location. The AI traffic management sensor 102 can be operable to communicate with such vehicles including autonomous vehicles and legacy vehicles. For example, the AI traffic management sensor 102 can communicate with legacy aircraft 120a, autonomous flying transport and delivery vehicles 120b, flying cars and taxis 120c, autonomous first aid and flying medical robots 120d, ground traffic 120e including autonomous cars and sea traffic 120f.

In one example, the AI traffic management sensor 102 can detect and communicate with traffic in and around the geographic location via an identification chip 110a-110f that is incorporated on vehicles moving in and around the geographic location. The identification chip 110a-110f can be any suitable chip can communicate with or that can otherwise be detectible by the AI traffic management sensor 102. For example, the identification chip 110a-110f can comprise a RFID chip comprising information identifying the vehicle into which the identification chip 110a-110f is incorporated. The identification chip 110a-110g can of course comprise any other suitable communication protocols for relaying identification information to the AI traffic management sensor 102.

In FIG. 1, there is one AI traffic management sensor 102 shown. However, it is to be understood that the system can comprise a plurality of AI traffic management sensors 102 throughout a geographic area. The AI traffic management sensor(s) 102 can each be connected to one or more servers. For example, the AI traffic management sensor(s) 102 can be connected to a local server 104 that receives information regarding traffic in and around the geographic location and that can provide solutions to the AI traffic management sensor(s) to direct, manage, and protect traffic in and around the geographic location in the AI traffic management system 10. The local server 104 can comprise one or more processors that are operable to utilize machine learning to provide solutions for the AI traffic management sensor 102 to interface with the various types of vehicles 120a-120f in real time as they travel in and around the geographic location. In this manner, the AI on the local server is operable to predict traffic events of the vehicles 120a-120f in order to safely direct and manage the traffic in and around the geographic location.

The AI traffic management sensor 102 can further be connected to remote servers or cloud servers 106. The remote servers 106 can further receive and relay information to the AI traffic management sensor 102 to aid in interacting with traffic in and around the geographic location in the AI traffic management system 10. The remote server 106 can act in parallel with or as an alternative to the local server 104. In some examples, the remote server 016 can comprise a deep learning module that is operable to find solutions for a plurality of potential scenarios encountered by the AI traffic management system 10 and can relay the solutions to the local server 104 or to the AI traffic management sensor 102.

The AI traffic management sensor 102 can further be connected to one or more decentralized servers 108. The decentralized servers 108 can comprise a plurality of servers that host one or more distributed ledgers comprising transaction information for the AI traffic management system 10. The transaction information can comprise information regarding authorizations to enter and travel through the geographic location via air, ground, or sea. Such authorizations can comprise payment information, navigational directions, and the like.

For example, the decentralized server 108 can host a distributed ledger or blockchain comprising one or more virtual wallets corresponding to the moving objects or vehicles 120-120f that desire to travel in and around a particular geographic location. The virtual wallets can be accessible by combining an encrypted public key and an encrypted private key. The public key can be stored on the decentralized server 108, and a private key can be held by an operator of the moving object or vehicle 120a-120f or can be maintained on the decentralized server and can be accessible by the operable of the moving object or vehicle 120a-120f. In some cases, the identification chip 110a-110f can comprise information to access the private key corresponding to the virtual wallet of a particular vehicle 120a-120f. The operators of moving objects/vehicles 120a-120f can utilize the virtual wallets to gain access to airspace, land, or sea managed by the AI traffic management system 10 in and around a geographic location and to safely travel within the geographic location. Each of the servers 104, 106, 108 can be termed an AI traffic management server.

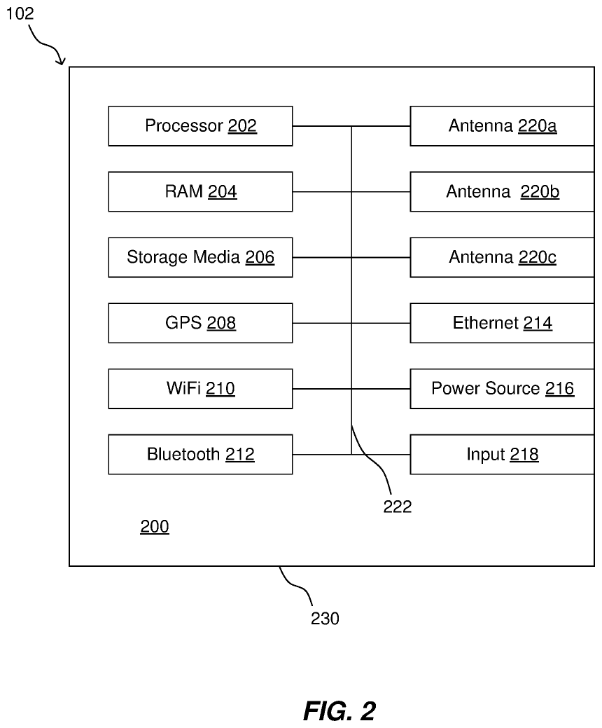

FIG. 2 is a schematic view of an artificially intelligent traffic management sensor. As shown in FIG. 2 an AI traffic management sensor 102 can comprise an enclosure 200 that houses a plurality of internal components facilitating the operation of the AI traffic management sensor 102. The enclosure 200 can be formed by a housing 230. The housing 230 can be formed from any suitable material providing sufficient weather, electrical, and secure protection to the internal components. For example, the housing 230 can be formed from a metal such as a titanium, aluminum, or an alloy thereof. Other material such as a polymer-based material can also be used. The housing 230 can comprise an enclosure rating of IP65, IP67 or greater to provide suitable protection to the internal components. The housing 230 can further facilitate an operating temperature range of −20 degrees centigrade to 50 degrees centigrade.

The AI traffic management sensor 102 can comprise a processor 202. The processor 202 can be any suitable processor operable to execute machine-readable instructions stored in a memory of the AI traffic management sensor 102. The processor 202 can comprise, for example, at least a 1 GHz, quad-core processor. The AI traffic management sensor 102 can further comprise RAM 204 and storage media 206. The RAM can comprise, for example, at least 2 gigabytes of DDR 3 memory. The storage media can comprise any suitable non-transitory storage media such as a hard drive, a solid-state drive, or the like. In one example, the storage media 206 can comprise at least 16 gigabytes of disk memory.

The AI traffic management sensor 102 can further comprise a plurality of communication modules to transmit and receive information from the moving objects/vehicles 120a-120f. For example, the sensor 102 can comprise a WiFi communication module 210 and Bluetooth communication module 212. These modules can be connected to one or more compatible antennas 220a-220c. Suitable antennas can include antennas such as models of antennas sold under the following trade names: Qualcomm Atheros QCA9982, XDee Pro 802.15.4, XDee Pro 868LP, and XDee Pro 900HP. The AI traffic management sensor 102 can further comprise a GPS module 208 that is connected to a suitable antenna 220a-220c.

The AI traffic management sensor 102 can further comprise a wired communication interface such as an Ethernet connection 214. The components of the AI traffic management sensor 102 can be powered by a power source 216 which can be connected to a battery housed in the enclosure 200 and/or which can be connected to an external power source. In one example, the power source 216 can comprise an AC/DC converter to convert AC power input to the power source 216 to DC power to operate the components of the sensor 102. In one example, the power source can provide 12V power to the internal components of the sensor 102. The sensor 102 can further comprise any number of other inputs 218 to provide information to the sensor 102. The various components of the AI traffic management sensor can be connected via a communications bus 222 that is operable to transmit information and/or power to the various components.

The components shown in the AI traffic management sensor 102 in FIG. 2 are exemplary, and the AI traffic management sensor 102 is not limited to the above components. For example, the AI traffic management sensor 102 can comprise transceivers to facilitate other communication protocols such as cellular communications including 4G and 5G communication standards used in various countries throughout the world. The AI traffic management sensors 102 can also comprise other sensors to detect moving objects/vehicles that do not communicate with the AI traffic management sensor 102, such as radar, lidar, or the like.

Further the AI traffic management system 10 can comprise AI traffic management sensors 102 that comprise different components. In some examples, some AI traffic management sensors 102 can be considered master sensors that are connected to a plurality of other slave sensors that relay information to the master sensor. In some examples, the slave sensors can have a simpler construction with fewer components and can be controlled by the master sensor.

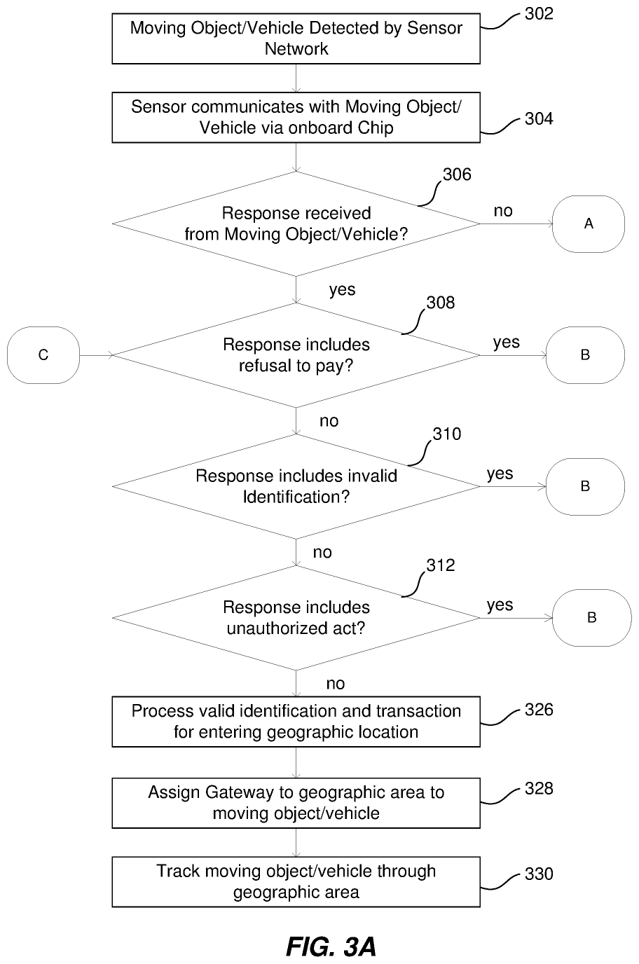

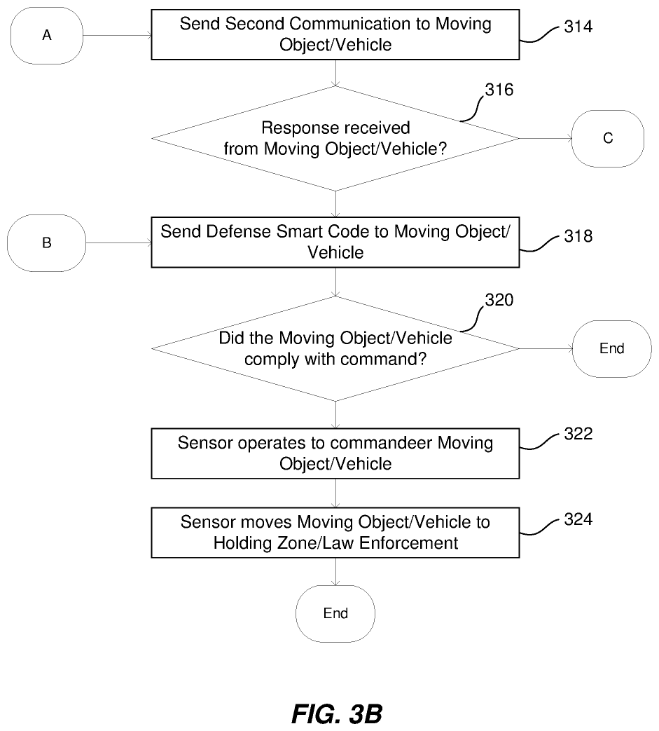

The operation of the AI traffic management system 10 and AI traffic management sensor 102 will be better understood in connection with FIGS. 3A and 3B which show a method of traffic management according to one exemplary embodiment. The method set forth in FIGS. 3A and 3B can also be utilized as pretraining for AI modules incorporated into the AI traffic management system 10. In step 302, when a moving object/vehicle 120a-120f approaches a geographic location in which traffic is managed by the AI traffic management system 10, the AI traffic management sensor 102 can detect the moving object/vehicle 120a-120f. The sensor 102 can detect the moving object/vehicle 120 by receiving information transmitted by the moving object/vehicle 120, such as by receiving information via any number of wireless protocols. In another example, the AI traffic management sensor 102 can detect the moving object/vehicle via radar, lidar, or other detection methods.

In step 304, the AI traffic management sensor 102 communicates with the moving object/vehicle 120 via the chip 110. For example, the AI traffic management sensor 102 can query the moving object/vehicle 120 to provide identification information about the moving object/vehicle 120 from the identification chip 110 incorporated into the moving object/vehicle 120. The sensor 102 can further query the moving object/vehicle about a desired destination in or around the geographic location.

In step 306, the sensor 102 can determine whether a response was received from the moving object/vehicle. If no response was received, the method proceeds to step 314. If a response was received, the method proceeds to step 308. In step 308, the sensor 102 receives a response from the moving object/vehicle 120. The response can be processed by the sensor 102 or can be related to one or more of the servers 104, 106, 108. It is determined whether the response includes a refusal to pay for entry into the geographic location or otherwise includes a refusal to comply with any terms set by the AI air traffic management system 10. If a refusal is included, the method proceeds to step 318. If not, the method proceeds to step 310.

In step 310, the sensor 102 or one of the servers 104, 106, 108 can validate the identification information to determine whether the identification information provided is authentic and approved. That is, the AI traffic management system 10 can determine whether the identification of the moving object/vehicle 120 is registered and authorized to enter and travel through the geographic location. In some cases, there may be differing levels of authorizations where only certain moving objects/vehicles 120 are authorized to enter more restricted areas, travel at certain speeds, or the like. If a valid identification is provided in step 310, then the method proceeds to step 312. If no valid identification is provided, then the method proceeds to step 318.

In step 312, the AI traffic management system 10 determines whether the moving object/vehicle performs any other unauthorized act around or within the geographic location. For example, the AI traffic management sensor 102 can determine whether an autonomous flying vehicle 120b (e.g. a drone) flies towards or into a restricted airspace, flies in a direction contrary to information provided by the autonomous flying vehicle 120b to the sensor 102, or the like. If an unauthorized act is detected by the AI traffic management sensor 102, the method proceeds to step 318. If no unauthorized act is detected, then the method proceeds to step 326. It is noted that the combination of steps 306, 308, 310, and 312 can be considered an authentication step or process for authenticating the moving object/vehicle to gain access to travel within the geographic location.

If no response was received from the moving object/vehicle 120 in step 306, the AI traffic management sensor can be configured to send a second communication to the moving object/vehicle 120 in step 314 in a second attempt to solicit a valid response from the moving object/vehicle 120. If a response is received from the moving object/vehicle in step 316, then the method returns to step 308. If a response still is not received from the moving object/vehicle 316, then the method proceeds to step 318.

In step 318, the AI traffic management sensor can be operable to send a smart defense code to the moving object/vehicle 120. The smart defense code can comprise one or more commands to the moving object/vehicle to instruct the moving/object vehicle to leave the geographic location or take other precautionary action. Such commands can comprise a turn-around order, a landing order, a request to control the moving object/vehicle, or the like. In other words, the AI traffic management sensor 102 can send a command to the moving object/vehicle to travel away from the geographic location or to land at a designated area. The smart defense code can comprise a feedback response to the AI traffic management sensor 102 to determine whether the moving object/vehicle complied with the one or more commands.

If the moving object/vehicle 120 complies with the command in step 320, then the method ends with respect to that particular moving object/vehicle. If the moving object/vehicle 120 is not compliant with the commands sent to it by the sensor 102 in step 320, then the method proceeds to step 322. In step 322 the AI traffic management sensor 102 in combination with one or more of the servers 104, 106, 108 operate to commandeer control of the moving object/vehicle 120. In other words, using one or methods or solutions provided by the AI of the AI traffic management system 10, the sensor 102 communicates with the moving object/vehicle 120 to hack into a control system of the moving object/vehicle to take direct command of the moving object/vehicle 120. Such solutions can include a simple or hybrid brute force attack or the like. The AI traffic management system can thus infiltrate and commandeer the moving object/vehicle 120 as more thoroughly set forth in U.S. Pat. No. 11,022,407, the contents of which are hereby incorporated by reference.

Once the moving object/vehicle 120 is in control of the AI traffic management system 10, the sensor 102 controls the moving object/vehicle 120 to a holding zone or other secured location, or otherwise takes appropriate action, such that the offending moving object/vehicle can be passed off to appropriate law enforcement authorities in step 324.

Returning to step 312, if a valid response including valid identification and no unauthorized acts is received, then the method proceeds to step 326. In step 326, the identification and a transaction are processed to allow the moving object/vehicle 120 to enter the geographic location. The identification information can comprise a private key which can be sent to the decentralized servers 108 hosting a blockchain or distributed ledger to access a virtual wallet corresponding with the moving object/vehicle 120. Alternatively, the identification information can include a request to create a virtual wallet and associated public and private keys corresponding with the moving object/vehicle. The private key can be generated at the decentralized server 108 using a randomized, encrypted, and unique hexadecimal code that can be incorporated in the identification chip 110 for each moving object/vehicle 120.

The virtual wallet can be used to provide payment, tokens, or other validation constituting an authentication media to the AI traffic management system 10 to gain access to a destination within the geographic location or to gain access to proceed through the geographic location. A user can connect the virtual wallet to payment information to purchase tokens or other authentication media to add to the virtual wallet. The authentication media can also comprise, for example, an authorization level that determines, for example, in what portion(s) of the geographic location the moving object/vehicle 120 is authorized to travel or at what speeds the moving object/vehicle is authorized to travel.

Based on the authorization in step 326, the AI traffic management system can assign a route or movement path through the geographic location to the virtual wallet of the moving object/vehicle 120. For an air vehicle, the route can be a virtual tunnel through an airspace in which the moving object/vehicle 120 navigates. For a land or sea vehicle, the route can be a predetermined path along a road or a sea lane. In some examples, when the moving object/vehicle 120 enters the geographic location, the control of the moving object/vehicle 120 can be handled by the AI traffic management sensor 120. The AI of the local or cloud server 104, 106 can provide real time solutions to provide an efficient and safe route for the moving object/vehicle as it moves through the geographic location. The route can be updated by the AI of the servers 104, 106 based on changing environmental conditions, interaction with other vehicles, a change in destination, or the like as the AI traffic management system tracks the moving object/vehicle through the geographic area in step 330. The AI of the servers 104, 106 can utilize machine learning to develop solutions for unique navigational situations in accordance with pretraining programmed into the AI which can account for collision avoidance, energy efficiency, time and speed to destination, and the like. The AI can facilitate unique solutions for any number of scenarios utilizing machine learning and deep learning techniques such that the AI traffic management system can accommodate an almost unlimited number of vehicles requesting access to and traveling within the geographic location.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method of controlling moving objects in and around a geographic location, the method comprising
obtaining an artificially intelligent (“AI”) traffic management sensor in communication with an AI traffic management server;
detecting one or more moving objects via the AI traffic management sensor; and
relaying instruction information regarding a movement path in and/or through a geographic location from the AI traffic management sensor to the one or more moving objects.

2. The method of claim 1, wherein the detecting one or more moving objects comprises receiving identification information from the one or more moving objects via an identification chip corresponding to each of the one or more moving objects.

3. The method of claim 2, wherein the identification information comprises a private key to access a virtual wallet stored in the AI traffic management server.

4. The method of claim 3, wherein the virtual wallet stores authentication media for gaining access for travel within the geographic location.

5. The method of claim 4, wherein the authentication media comprises at least one of payment for gaining access for travel within the geographic location and authorization to travel in one or more portions of the geographic location.

6. The method of claim 2, further comprising authenticating the one or more moving objects based on the identification information received from the one or more moving objects.

7. The method of claim 1, wherein the relaying instruction information comprises relaying solutions regarding the movement path based on machine learning performed on the AI traffic management server.

8. The method of claim 7, wherein the solutions are in accordance with pretraining programmed into the AI traffic management server, the pretraining accounting for at least one of collision avoidance, energy efficiency, and time to arrive at a destination.

9. The method of claim 1, wherein the detecting one or more moving objects comprises sending a query from the AI traffic management sensor to the one or more moving objects for identification information.

10. The method of claim 9, wherein when no response to the query is received at the AI traffic management sensor, the method further comprises sending a command to the one or more moving objects via the AI traffic management sensor to travel away from the geographic location or to land at a designated area.

11. The method of claim 10, wherein when the one or more moving objects fails to comply with the command sent from the AI traffic management sensor, the method further comprises commandeering control of the one or more moving objects via the AI traffic management sensor to directly control the one or more moving vehicles.

12. The method of claim 11, wherein the commandeering comprises receiving solutions generated from the AI traffic management server at the AI traffic management sensor to hack into a control system of the one or more moving objects.

13. A system for controlling moving objects in and around a geographic location, the system comprising:
one or more artificially intelligent (“AI”) sensors operable to detect the moving objects and to transmit instruction information to the moving objects regarding a path through the environment; and
one or more AI servers communicatively coupled to the one or more AI sensors, the one or more AI servers being operable to detect and predict traffic events of the moving objects.

14. The system of claim 13, further comprising one or more decentralized servers hosting a distributed ledger comprising transaction information utilizing virtual wallets associated with each of the moving objects, the transaction information corresponding to a transaction of authentication media to allow the moving objects to travel within the geographic location.

15. The system of claim 14, wherein the virtual wallets are accessed by the one or more decentralized servers receiving identification information from the moving objects via an identification chip corresponding to each of the moving objects.

16. The system of claim 15, wherein the identification information comprises a private key to access a virtual wallet stored in the AI traffic management server.

17. An artificially intelligent (“AI”) sensor, comprising:
an AI chip disposed within the AI sensor,
one or more sensors configured to detect moving objects in and around a geographic location; and
a transceiver configured to send and receive information to and from the moving objects in and around the geographic location.

18. The AI sensor of claim 17, wherein the transceiver is operable to receive identification information from the moving object via an identification chip corresponding to each of the moving objects.

19. The AI sensor of claim 18, wherein the identification information comprises a private key to access a virtual wallet stored in an AI traffic management server communicatively coupled to the AI.

20. The AI sensor of claim 19, wherein the virtual wallet stores authentication media for gaining access for travel within the geographic location, and wherein the transceiver is operable to relay instruction information regarding a movement path in and/or through a geographic location from the AI traffic management server to the one or more moving objects based on authenticating the moving objects via the authentication media.
